(19) United States
(12) Patent Application Publication
(10) Pub. No.: US 2020/0309180 A1
(43) Pub. Date: Oct. 1, 2020

(54) Tacking Device For The At Least Temporary Fastening Of Components To One Another

(71) Applicant: Airbus Operations GmbH, Hamburg (DE)

(72) Inventors: Joern Skirke, Hamburg (DE); Steffen Kornhuber, Hamburg (DE); Alexander Gessenharter, Hamburg (DE)

(73) Assignee: Airbus Operations GmbH, Hamburg (DE)

(21) Appl. No.: 16/809,802

(22) Filed: Mar. 5, 2020

(30) Foreign Application Priority Data
Mar. 27, 2019 (DE) 10 2019 107 820.2

(51) Int. Cl. F16B 19/10; B21J 15/04

(52) U.S. Cl. CPC F16B 19/1063; B21J 15/043; F16B 19/1054

(57) ABSTRACT

A tacking device for a temporary fastening of components has a sleeve having a first end, a second end, an axial hole and a radially projecting collar at the first end, and an elongate mandrel having a head end and a tensioning end. The mandrel can be inserted into the axial hole at the second end of the sleeve, can be brought into stop contact with a sleeve rim surface by the head end and projects beyond the first end from the sleeve in the inserted state. A holding unit is designed to hold the mandrel when the tacking device is inserted into an opening of a component. The sleeve has a deformable material, which is squashed against the component when is inserted into an opening of a component. The mandrel has a predetermined breaking point with a weakened cross section, positioned between the head end and the tensioning end.

### FIELD OF THE INVENTION

The invention relates to a tacking device for the at least temporary fastening of components to one another and to a method for the at least temporary fastening of components to one another.

### BACKGROUND OF THE INVENTION

In the production of large components, e.g. aircraft fuselages, riveting methods are often used. If, for example, the intention is to connect individual axial sections of aircraft fuselages, also referred to as fuselage barrels, to one another with the aid of riveted joints, precise alignment of these sections relative to one another is required. There is a known practice of positioning the joining surfaces of the fuselage barrels to be connected relative to one another with the aid of movable support frames in order then to jointly drill the joining surfaces and to fit them with riveted joints. Aligning the joints is a laborious process, as is the production of through holes. These generally require that the components to be connected to one another be moved apart after the actual drilling, that the holes subsequently be deburred, that the joining surfaces be cleaned and that a sealant be applied. Only then are the fuselage barrels positioned on one another again and the riveted joints produced.

There are known methods which are based on a similar principle. However, in this case not all the holes, but only about 20-50%, are made in the joining surfaces, these being sufficient to achieve adequately firm tacking of the components to one another. These holes are cleaned and deburred as usual, and the joining surfaces are provided with a sealant and realigned relative to one another. Tacking devices, which comprise screwed or bolted joints for instance, are inserted into the already produced holes. After the components have been tacked to one another, riveted joints are produced by means of automated devices and methods at all the other holes provided, wherein the laborious process of deburring and cleaning is eliminated since there is sufficient surface pressure of the components with respect to one another at the corresponding drilling locations. After the formation of the riveted joints, the tacking devices are removed, and the holes which are then exposed are subsequently likewise provided with riveted joints.

### BRIEF SUMMARY OF THE INVENTION

While tacking has a particularly great advantage in the production of the desired riveted joints, the mounting and release of the tacking devices themselves is relatively laborious. The manual effort is high and the costs for the tacking devices, which can be used multiple times and are to be mounted manually, are relatively high. Automated production of the tacked joints is difficult.

Consequently, an aspect of the invention relates to a tacking device for fastening two components to one another at least temporarily which eliminates the disadvantages mentioned above. In particular, an aspect of the invention proposes a tacking device which can be used in a way which is as simple and automated as possible, can be implemented at particularly low cost and yet provides a tacking force which is as high as possible.

The proposal is for a tacking device for the at least temporary fastening of components to one another, having a sleeve having a first end, a second end, an axial hole and a radially projecting collar at the first end, an elongate mandrel having a head end and a tensioning end, wherein the mandrel can be inserted into the axial hole at the second end of the sleeve, can be brought into stop contact with a sleeve rim surface by means of the head end and projects beyond the first end from the sleeve in the inserted state, wherein a holding unit is provided, which is designed to hold the mandrel when the tacking device is inserted into an opening of a component, wherein the sleeve has a deformable material, which is squashed against the component when the tacking device is inserted into an opening of a component, as the head end of the mandrel is moved in the direction of the first end of the sleeve, and wherein the mandrel has a predetermined breaking point with a weakened cross section, which is positioned between the head end and the tensioning end and which is designed to ensure that, with the sleeve squashed, the mandrel breaks at the predetermined breaking point and a section having the tensioning end is detached.

Consequently, the tacking device according to an embodiment of the invention has at least two components. The sleeve composed of a deformable material preferably has a cylindrical, elongate, round shape, which has two ends. The first end has a radially projecting collar, which is embodied like a flat circular disc, for example, and preferably ends flush with the first end. The opposite, second end is an insertion end, which is inserted into the opening in the components concerned. The sleeve has an axial hole, into which the mandrel is inserted.

The mandrel has a preferably elongate, solid-cylindrical, rectilinear shape, which exceeds the length of the sleeve. The head end could likewise have a radially projecting collar, which comes into surface contact with an end-located sleeve rim surface at the second end of the sleeve. When the mandrel is in surface contact by means of the head end with the sleeve rim surface, it extends completely through the axial hole and projects from the first end.

If the sleeve is inserted into an opening, i.e. if the second end of the sleeve is introduced into an opening, it is possible, by pressing on the collar, to align the sleeve with respect to the opening by stop contact of the collar on the sleeve rim surface. The sleeve should remain in this position. By means of the holding unit, which is of generally arbitrary shape, the mandrel is held fast in this position in the sleeve. Consequently, tacking devices of this kind can be successively gripped and inserted automatically, and they are well-suited to automatic processing. The introduction of the mandrel after the insertion of the sleeve into the opening is not necessary.

The projecting mandrel allows gripping by a gripping device of a robot-guided tool. The tool is designed to move the mandrel in such a way that the annular surface in surface contact with the head end at the second end of the sleeve is pulled in the direction of the collar, with the result that the sleeve is squashed against the component. As explained further below, the movement of the mandrel can include pulling or rotating the mandrel. By means of the holding unit, the mandrel is held even when the sleeve is squashed. Consequently, the sleeve is in turn held by the mandrel in the squashed position.

Owing to the predetermined breaking point positioned between the head end and the tensioning end, the mandrel can break when a predetermined tensile stress, which represents a squashed state of the sleeve for example, is reached. In this case, the predetermined breaking point is arranged in such a way that it lies within the sleeve. This is particularly advantageous since, after the production of riveted joints, the tacking device is released again and, by virtue of the broken-off part of the mandrel, part of the axial hole in the sleeve then acts as a guide for a drill or milling cutter, which can be introduced at least partially into the axial hole in order then to drill out the mandrel and the sleeve. This makes it easy to expel the sleeve from the opening, and consequently the tacking device can fall out of the opening after being used and can be collected up after the completion of the riveted joints.

Consequently, the particular advantage consists in the possibility of implementing the device at low cost and for single use and in furthermore allowing handling with an automatic processing device. This can already include the insertion of the tacking device into an opening, the production of the squashed joint and the subsequent removal by means of cutting. The provision of a holding unit to hold the mandrel can be used to achieve a high tacking force. It is thereby possible to significantly reduce the costs for the tacking device and to speed up handling. The tacking device according to the invention requires access from only one side, both for setting and removal, e.g. drilling out, thereby achieving simple automation of setting and drilling out. Overall, therefore, an effective, low-cost and easily handled tacking device for single use is proposed.

In an advantageous embodiment, the holding unit is formed by a funnel-shaped section at the first end of the axial hole and by a separate collar element, wherein the collar element has a radial projection, and an insertion section, which extends axially and in a tapering manner from the latter, is designed in a manner corresponding to the funnel-shaped section and has a through hole for the passage of the mandrel. Consequently, the collar element can be inserted by means of the insertion section into the funnel-shaped section of the axial hole. The mandrel can be passed through the hole in the collar element, with the result that the mandrel extends completely through the sleeve and the collar element. As a result, the mandrel can be held on the tacking device by means of the collar element. As the collar element is inserted into the funnel-shaped section, radial clamping takes place between the sleeve, the collar element and the mandrel. The funnel-shaped section is dimensioned in such a way that, although it projects significantly into the sleeve, it also falls significantly below the total axial length of the sleeve. The insertion section and the funnel-shaped section can have a widening or taper angle which is significantly below 45° and, by way of example, at least 5°, for example. A certain wedging effect for radial clamping can thereby be achieved. With the collar element situated completely in the funnel-shaped section, the radial projection of the collar element can rest on the collar of the sleeve. Consequently, the radial projection of the collar element is preferably smaller than the collar of the sleeve.

Consequently, at least one first engagement element could be arranged in the funnel-shaped section, extending part way round an inner surface of the funnel-shaped section, wherein at least one second engagement element is arranged on the insertion section, extending part way round an outer surface of the insertion section, said second engagement element being designed to enter into a latching connection with the first engagement element. Consequently, the engagement elements of the insertion section and of the funnel-shaped section of the axial hole engage in one another and thus form a coherent unit. It is thereby possible to achieve particularly robust pre-assembly of the tacking device since the three elements can be assembled and loosely connected to one another without the risk that the tacking device will fall apart during storage, handling and insertion. Moreover, the tacking force is significantly enlarged by the engagement elements.

The first engagement element and the second engagement element are then preferably designed as latching elements. By embodying the engagement elements as latching elements, it is possible to achieve a latching joint which is particularly easy to establish. All that is then required is to insert the collar element into the funnel-shaped section of the axial hole and to press it lightly, thus giving rise to a latching joint capable of bearing high loads.

In a preferred variant, the first engagement element and the second engagement element are designed as barbs. In the case of embodiment as barbs, the latching joint is very easy to establish, as with a cable tie. However, the joint is virtually inseparable or capable of being separated only with considerable expenditure of force, which leads to the destruction of the barbs. Consequently, the barbs can enhance reliability in use.

As an alternative, it would also be possible for the first engagement element and the second engagement element to be designed as threads. A separate joint between the collar element and the funnel-shaped section of the axial hole is not necessary. On the contrary, the mandrel can be held on the collar element by the thread, and as the mandrel is moved in the direction of the collar, the collar element is also squashed into the axial hole. It is thereby possible to improve the quality of the connection of the sleeve in the opening of the components to be connected. The tacking force is very high and, given a suitable design of the threads to achieve self-locking, is also permanent, i.e. until the mechanical removal of the mandrel.

As a further advantageous possibility, the radial projection of the collar element could be designed to be placed on the collar when the collar element is pressed into the funnel-shaped section of the sleeve. Consequently, the radial projection of the collar element itself forms a collar and can be used to guide the collar element on the sleeve and hence on the components to be connected to one another.

In an advantageous variant, the collar element has a deformable material, wherein the collar element is designed to be squashed radially inwards when it is pressed into the funnel-shaped section. The squashing brings about radially continuous surface or material contact, which can increase the tacking force.

The predetermined breaking point of the mandrel could be spaced apart axially from the radial projection in the direction of the insertion section. Consequently, there is axial guidance for a drill or a milling cutter in the collar element provided by a fracture surface of the mandrel, which surface is spaced apart from an outer end of the through hole.

Moreover, the holding unit could be formed by an internal thread integrated into the sleeve and an external thread arranged on the mandrel. In this variant, just two parts are then necessary for the tacking device according to the invention. Apart from the sleeve, only the mandrel is provided, which is held on the sleeve by the internal thread. For this purpose, the first end of the sleeve can be embodied with a greater material thickness than the second end, which is designed for squashing. In this variant too, the achievable tacking force is very high.

The mandrel is preferably composed of a stronger material than the sleeve. Consequently, the mandrel can then be produced at very low cost and with a low material thickness and is not subject to the risk that the mandrel will be stretched during squashing of the sleeve. It is conceivable to produce the sleeve from an aluminium alloy or a plastic. The mandrel could be produced from a steel or from an aluminium alloy. The collar element could likewise be produced from an aluminium alloy or a plastic.

In implementing the tacking device according to an embodiment of the invention, it is expedient if possible for all the parts of the tacking element which come into direct contact with the components or the hole to be produced from plastic. It is thereby possible to avoid damage, such as scratches, to the component. This is expedient particularly when used for tacking fuselage components of an aircraft. Here, the plastic should be selected in such a way that a sufficient clamping force can be achieved.

The invention furthermore relates to a method for tacking two components to one another, having the steps of inserting a tacking device described above into a through opening in two components, and moving the mandrel in a direction towards the first end of the sleeve in order to squash the sleeve against the components until the mandrel breaks.

After the use of the tacking device, the method can have the steps of drilling a remaining part of the mandrel out of the tacking device, and removing the sleeve.

### BRIEF DESCRIPTION OF THE DRAWINGS

Further features, advantages and possible uses of the present invention will be found in the following description of the illustrative embodiments and the figures. Here, all the features described and/or depicted, in themselves and in any desired combination, form the subject matter of the invention, even when considered independently of their combination in the individual claims or the dependency references thereof. In the figures, the same reference signs furthermore stand for identical or similar objects.

FIGS. 1 to 4 show a first illustrative embodiment in different states in a section from the side.

FIG. 5 shows a second illustrative embodiment in a fastened state in a section from the side.

FIGS. 6 and 7 show a third illustrative embodiment in an unfastened state and in a fastened state in a section from the side.

### DETAILED DESCRIPTION

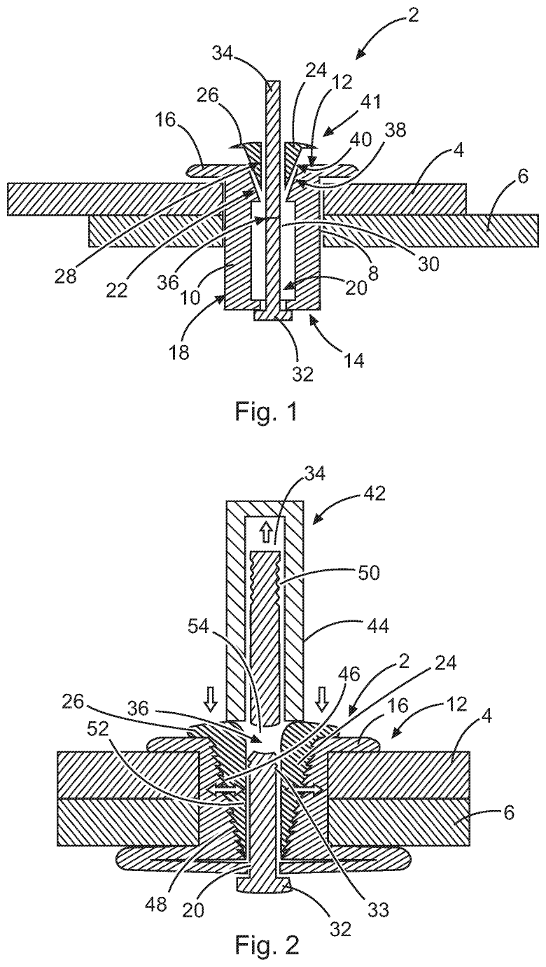

FIG. 1 shows a tacking device 2 for the at least temporary fastening of components 4 and 6 to one another. Here, the tacking device 2 is shown inserted into an opening 8. The components 4 and 6 can be, for example, sheet-like or flat components for a section of an aircraft fuselage, which are tacked to one another before the final production of riveted joints.

The tacking device 2 has a sleeve 10 with a first end 12 and a second end 14. Provided at the first end 12 is a radially projecting collar 16, which, by way of example, has a circular base surface. Otherwise, the sleeve 10 has a cylindrical lateral surface 18, which, in the example shown, has a constant outside diameter from below the collar 16 to the second end 14. Provided in the sleeve 10 is an axial hole 20, which, along a significant part of the sleeve 10, has a larger diameter than at the second end 14. A funnel-shaped section 22, which widens in the direction of the first end 12, is formed at the first end 12.

Moreover, a collar element 24 having a radial projection 26 and an insertion section 28 that tapers from the projection 26 is provided. The collar element 24 is inserted in the funnel-shaped section 22 of the axial hole 20. A mandrel 30 extends in the axial hole 20, and has a head end 32 and a tensioning end 34. The head end 32 has a larger outside diameter than the axial hole 20 at the second end 14. The mandrel 30 furthermore extends through the collar element 24 and projects outwards from the sleeve 10.

Between the head end 32 and the tensioning end 34, the mandrel 30 has a predetermined breaking point 36, which has a weakened cross section and is designed to cause the mandrel 30 to break when a certain tensile stress is exceeded in the mandrel 30. The tacking device 2 is designed in such a way that, first of all, the sleeve 10 can be inserted into the opening 8 concerned, with the result that the collar 16 comes into surface contact with a surface of the upper component 4. The sleeve 10 is thus positioned correctly in the opening 8. By holding down the collar 16 and simultaneously removing the mandrel 30, i.e. moving the head end 32 in the direction of the first end 12 of the sleeve 10, the sleeve 10 is squashed towards the component 6 on a lower side of the lower component 6.

By means of the collar element 24 introduced into the funnel-shaped section 22, the mandrel 30 can initially be held in the sleeve 10. During this process, there is initially only slight clamping of the mandrel 30 in the collar element 24 and the sleeve 10. When the sleeve 10 is squashed, tacking can be further improved by the clamping of the mandrel 30. In order to assist this, an inner surface 38 of the funnel-shaped section 22 can be provided with engagement elements in the form of latching elements (not visible here), wherein an outer surface 40 of the collar element 24 is equipped with corresponding engagement elements embodied as latching elements (likewise not visible here). By virtue of the insertion of the collar element 24 into the funnel-shaped section 22, the collar element 24 consequently latches into the funnel-shaped section 22 and, in the process, holds the mandrel 30 fast. Consequently, the elements involved in this can be regarded as a holding unit 41.

The longitudinal extent of the funnel-shaped section 22 is dimensioned in such a way that it does not exceed a minimum clamping length of the components 4 and 6 to be clamped. Consequently, the tacking device 2 can also be employed for different clamping lengths. Moreover, just two components 4 and 6 to be connected to one another are shown purely by way of example in the figures. It is self-evident that it is also possible for more than two components to be tacked and for the clamping length then to be greater than shown here. This applies to all of the illustrative embodiments.

As illustrated in FIG. 2, this tacking device 2 is suitable particularly for automated handling from a single side of the components 4 and 6. The insertion of the tacking device and the subsequent clamping can take place completely without manual intervention. For this purpose, a robot-guided tool 42, illustrated schematically here, is shown, said tool having a mount-on sleeve 44, by means of which the collar element 24 is pressed into the funnel-shaped section 22 of the sleeve 10. During this process, second engagement elements 46 enter into a latching connection with first engagement elements 48 of the sleeve 10. In FIG. 2, the engagement elements 46 and 48 are embodied as barbs. At the same time, the mandrel 30 is pulled in the direction of the first end 12 by the tool 42, with the result that the second end 14 of the sleeve 10 is squashed against the lower component 6 from below. To facilitate the exertion of a tensioning force on the mandrel 30, the mandrel has a plurality of groove-shaped depressions 50 on its tensioning end 34. After the state shown in FIG. 2 has been reached, with the sleeve 10 fully squashed, a limiting stress can be reached, leading to the breaking of the mandrel 30 at the predetermined breaking point 36. Consequently, part of the mandrel 30 breaks off and, as a result of this, part of a through hole 52 in the collar element 24 remains free. This makes it possible to insert a cutting tool into a cavity 54 arising as a result in order to remove the mandrel 30 again and, together with it, the entire tacking device 2. That part of the mandrel 30 which has been broken off is clamped fast by the collar element 24. This is promoted by further groove-type depressions 33, which are connected non-positively and/or positively to the collar element 24. The tensioning force of the mandrel 30 can thus be transmitted to the collar element 24.

The squashing of the sleeve against the lower component 6 gives rise to a sufficiently high surface pressure between the two components 4 and 6. At a short distance therefrom, the surface pressure may be sufficient to simultaneously drill both components 4 and 6 without a separate clamping device and without drillings getting between the two components 4 and 6. Consequently, it is possible, through the arrangement of several tacking devices 2, which fill between 20 and 50% of all holes to be produced for example, which are provided for the production of riveted joints. This may be sufficient to produce all the remaining 50-80% of the riveted joints in one pass with tacking devices 2 inserted. The tacking devices 2 can then all be removed in order to implement respective final riveted joints in their stead.

FIG. 3 shows the same illustration as FIG. 2 but without a robot-guided tool 42. Here, the cavity 54, which can be used to receive and guide a drill 55 or milling cutter, is readily visible. This is illustrated in FIG. 4, as it successively removes the mandrel 30. Here, the selected diameter of the drill 55 is somewhat greater than the diameter of the mandrel 30.

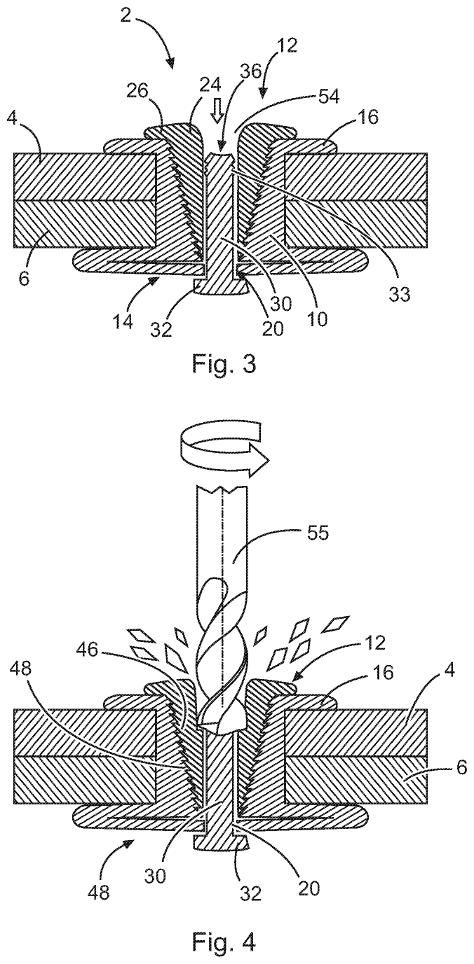

FIG. 5 shows an alternative embodiment in the form of a tacking device 56. Here, a collar element 58 is provided, which has an internal hole 60 with an internal thread 62. A mandrel 64 having an external thread 66 extends through the collar element 58. A holding unit 67 is thereby formed. A sleeve 68 is of very similar design to sleeve 10 but does not have any engagement elements 48. In FIG. 5, the squashed sleeve 68 is already shown, and the mandrel 64 is already broken at a predetermined breaking point 70. Here, the movement of the mandrel 64 takes the form of rotation. The threads 62 and 66 allow very good clamping when the mandrel 64 is broken by means of a non-positive joint.

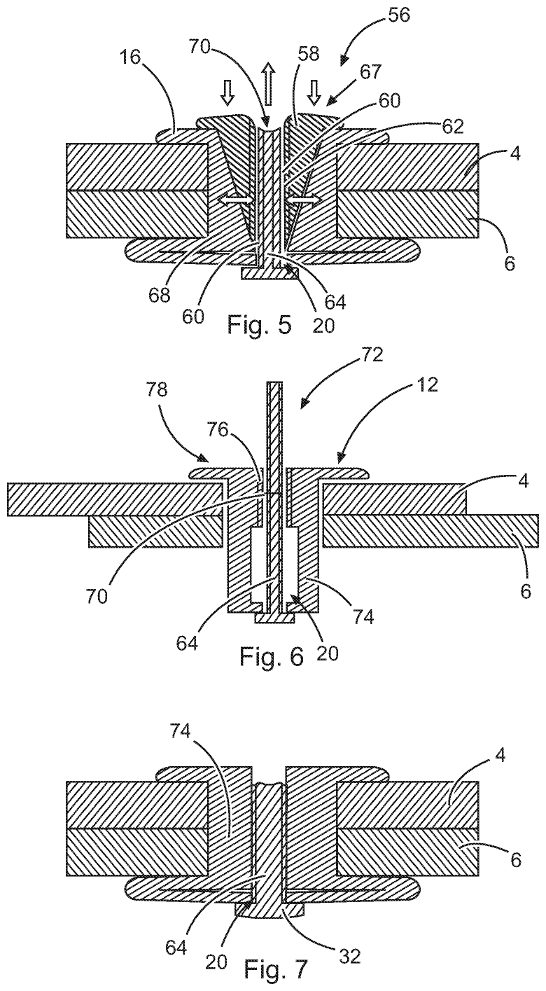

FIG. 6 shows another variant of a tacking device 72, which consists of just two parts. Here, the mandrel 64 from FIG. 5 is combined with another sleeve 74, which has an internal thread 76 only at its first end 12. The extent of the internal thread 76 is dimensioned in such a way that it does not exceed a minimum clamping length of the components 4 and 6 to be clamped. A holding unit 78 is thereby formed. This is a particularly simple variant since just two components have to be used. As shown in FIG. 7, adequate squashing is also possible without a collar element. A non-positive joint is achieved by threads 66 and 76 of self-locking design.

For the sake of completeness, it should be noted that “having” does not exclude any other elements or steps and “a” or “an” does not exclude a multiplicity. It should furthermore be noted that features which have been described with reference to one of the above embodiment examples can also be used in combination with other features of other embodiment examples described above. Reference signs in the claims should not be regarded as restrictive.

### REFERENCE SIGNS

1 tacking device
4 component
6 component
8 opening
10 sleeve
12 first end
14 second end
16 collar
18 lateral surface
20 axial hole
22 funnel-shaped section
24 collar element
26 projection
28 insertion section
30 mandrel
32 head end
33 depression
34 tensioning end
36 redetermined breaking point
38 inner surface
40 outer surface
41 holding unit
42 tool
44 mount-on sleeve
46 second engagement element
48 first engagement element
50 depression
52 hole
54 cavity
55 drill
56 tacking device
58 collar element
60 hole/internal hole
62 internal thread
64 mandrel
66 external thread
67 holding unit
68 sleeve
70 predetermined breaking point
72 tacking device
74 sleeve
76 internal thread
78 holding unit

1. A tacking device for the at least temporary fastening of components to one another, comprising:
a sleeve having a first end, a second end, an axial hole and a radially projecting collar at the first end; and
an elongate mandrel having a head end and a tensioning end;
wherein the elongate mandrel is configured to be inserted into the axial hole at the second end of the sleeve, to be brought into stop contact with a sleeve rim surface by the head end and to project beyond the first end from the sleeve in the inserted state,
wherein the tacking device further comprises a holding unit, configured to hold the elongate mandrel when the tacking device is inserted into an opening of a component,
wherein the sleeve has a deformable material, configured to be squashed against the component when the tacking device is inserted into an opening of a component, as the head end of the mandrel is moved in the direction of the first end of the sleeve, and
wherein the mandrel has a predetermined breaking point with a weakened cross section, positioned between the head end and the tensioning end and configured to ensure that, with the sleeve squashed, the mandrel breaks at the predetermined breaking point and a section having the tensioning end is detached.

2. The tacking device according to claim 1,
wherein the holding unit is formed by a funnel-shaped section at the first end of the axial hole and by a separate collar element, and
wherein the collar element has a radial projection, and an insertion section extending axially and in a tapering manner from the latter, configured in a manner corresponding to the funnel-shaped section and having a through hole for the passage of the mandrel.

3. The tacking device according to claim 2, further comprising:
at least one first engagement element arranged in the funnel-shaped section, extending part way round an inner surface of the funnel-shaped section, and
at least one second engagement element arranged on the insertion section, extending part way round an outer surface of the insertion section, said second engagement element configured to enter into a latching connection with the first engagement element.

4. The tacking device according to claim 3, wherein the first engagement element and the second engagement element are configured as latching elements.

5. The tacking device according to claim 3, wherein the first engagement element and the second engagement element are configured as barbs.

6. The tacking device according to claim 2, wherein the holding unit is in the form of an internal thread in the through hole of the collar element and of an external thread on the mandrel.

7. The tacking device according to claim 2, wherein the radial projection of the collar element is configured to be placed on the collar when the collar element is pressed into the funnel-shaped section of the sleeve.

8. The tacking device according to claim 2,
wherein the collar element has a deformable material, and
wherein the collar element is configured to be squashed radially inwards when the collar element is pressed into the funnel-shaped section.

9. The tacking device according to claim 2, wherein the predetermined breaking point of the mandrel is spaced apart axially from the radial projection in the direction of the insertion section.

10. The tacking device according to claim 1, wherein the holding unit is formed by an internal thread integrated into the sleeve and an external thread arranged on the mandrel.

11. The tacking device according to claim 1, wherein the mandrel is composed of a stronger material than the sleeve.

12. A method for tacking two components to one another, the method comprising:
inserting a tacking device according to claim 1 into a through opening in the two components, and
moving the mandrel in a direction towards the first end of the sleeve in order to squash the sleeve against the components until the mandrel breaks.

13. The method according to claim 12, further comprising, after a use of the tacking device:
drilling a remaining part of the mandrel out of the tacking device, and
removing the sleeve.
